(19) United States
(12) Patent Application Publication
(10) Pub. No.: US 2025/0033910 A1
(43) Pub. Date: Jan. 30, 2025

(54) MEDIUM ACCOMMODATING DEVICE AND IMAGE FORMING SYSTEM

(71) Applicant: FUJIFILM Business Innovation Corp., Tokyo (JP)

(72) Inventor: Yoshiki KIMURA, Kanagawa (JP)

(21) Appl. No.: 18/438,061

(22) Filed: Feb. 9, 2024

(30) Foreign Application Priority Data
Jul. 27, 2023 (JP) 2023-122794

(51) Int. Cl. B65H 3/08; B65H 7/16

(52) U.S. Cl. CPC B65H 3/08; B65H 7/16; B65H 2404/74; B65H 2406/10

(57) ABSTRACT

A medium accommodating device includes: a loading unit on which media are loadable in an up-down direction; a first restricting unit that is provided in the loading unit and restricts a position of a side portion of a medium in a width direction intersecting a transport direction of the medium according to a dimension of the medium in the width direction; an air supply unit that supplies air to plural media loaded on the loading unit to float and separate the plural media; a transporting unit that sequentially sends the media that are floated and separated by the air supply unit; a photographing unit that photographs a state in which the media are floated and separated by the air supply unit from an outside of the medium in the width direction; a second restricting unit that is attached to the loading unit when a narrow medium having dimensions in the width direction smaller than dimensions of the medium is loaded on the loading unit, and restricts a position of a side portion of the narrow medium in the width direction; and a focal distance changing unit that is installed at a position facing the photographing unit in a state in which the second restricting unit is attached, and aligns a focal point of the photographing unit with the side portion of the narrow medium in the width direction by changing a focal distance.

### CROSS-REFERENCE TO RELATED APPLICATIONS

This application is based on and claims priority under 35 USC 119 from Japanese Patent Application No. 2023-122794 filed Jul. 27, 2023.

### BACKGROUND

### (i) Technical Field

The present disclosure relates to a medium accommodating device and an image forming system.

### (ii) Related Art

JP2015-24868A discloses a sheet supply device including: a loading unit on which a sheet bundle in which a plurality of sheets are stacked in an up-down direction can be arranged; a blowing unit that blows air toward the sheet bundle disposed on the loading unit to cause at least the sheet in an uppermost layer to be floated; a sticking/transporting unit that is provided above the loading unit and causes the sheet in the uppermost layer floated by the blowing unit to stick to the sticking/transporting unit and transports the sheet in a predetermined transport direction; a first light source that emits a band-shaped first slit light having a component extending in the up-down direction, the first slit light intersecting a first edge of at least a first sheet from among the plurality of sheets floated and a second edge of a second sheet below the first sheet; a photographing unit that photographs the first slit light irradiating the first sheet and the second sheet and has a photographing direction different from a direction of the first slit light emitted by the first light source on a plane parallel to the first sheet and the second sheet; a calculating unit that calculates an interval between the first sheet and the second sheet in the up-down direction based on the first slit light photographed by the photographing unit; and a flow rate adjusting unit that adjusts a flow rate of the blowing unit based on the interval between the first sheet and the second sheet in the up-down direction calculated by the calculating unit.

### SUMMARY

Aspects of non-limiting embodiments of the present disclosure relate to a medium accommodating device and an image forming system capable of accurately photographing a floated and separated state of a narrow medium compared to a case where a focal position of a photographing unit does not change when a second restricting unit that restricts a position of a side portion of a narrow medium in a width direction, which has smaller dimensions in the width direction than a medium, is attached.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a medium accommodating device includes: a loading unit on which media are loadable in an up-down direction; a first restricting unit that is provided in the loading unit and restricts a position of a side portion of a medium in a width direction intersecting a transport direction of the medium according to a dimension of the medium in the width direction; an air supply unit that supplies air to a plurality of the media loaded on the loading unit to float and separate the plurality of media; a transporting unit that sequentially sends the media that are floated and separated by the air supply unit; a photographing unit that photographs a state in which the media are floated and separated by the air supply unit from an outside of the medium in the width direction; a second restricting unit that is attached to the loading unit when a narrow medium having dimensions in the width direction smaller than dimensions of the medium is loaded on the loading unit, and restricts a position of a side portion of the narrow medium in the width direction; and a focal distance changing unit that is installed at a position facing the photographing unit in a state in which the second restricting unit is attached, and aligns a focal point of the photographing unit with the side portion of the narrow medium in the width direction by changing a focal distance.

### BRIEF DESCRIPTION OF THE DRAWINGS

Exemplary embodiment(s) of the present invention will be described in detail based on the following figures, wherein:

FIG. 1A is a front view showing a part of a medium accommodating device according to a first exemplary embodiment, and FIG. 1B is a schematic view showing an example of an image forming system including the medium accommodating device;

FIG. 2 is a plan view showing a part of the medium accommodating device according to the first exemplary embodiment;

FIG. 3 is a side view showing a state of the medium accommodating device according to the first exemplary embodiment as viewed from a sending direction of a sheet;

FIG. 4 is a side view showing a state in which a small size guide is attached to a side guide of the medium accommodating device according to the first exemplary embodiment;

FIG. 5 is a perspective view showing a process of attaching a conversion lens to a camera in the state in which the small size guide is attached to the side guide of the medium accommodating device according to the first exemplary embodiment;

FIG. 6 is an enlarged perspective view showing a state in which the small size guide is attached to the side guide and the conversion lens is attached to the camera;

FIG. 7A is a perspective view showing the conversion lens, and FIG. 7B is a perspective view showing the camera provided in the side guide;

FIG. 8A is a diagram showing an example of a state in which floating and separation of sheets are good, FIG. 8B is a diagram showing an example of a state in which the floating and separation of the sheets are insufficient, and FIG. 8C is a diagram showing another example of the state in which the floating and separation of the sheets are insufficient;

FIG. 9 is a perspective view showing a state in which a small size guide is attached to a side guide of a medium accommodating device according to a second exemplary embodiment and a conversion lens is moved to a position facing a camera;

FIG. 10A is a perspective view showing a part of the small size guide, and FIG. 10B is a perspective view showing the conversion lens;

FIG. 11 is a perspective view showing a state in which a small size guide is attached to a side guide of a medium accommodating device according to a third exemplary embodiment and a camera is moved to a conversion lens side;

FIG. 12 is a perspective view showing the small size guide and a conversion lens;

FIG. 13 is a perspective view showing a moving device of the camera before attaching the small size guide to the side guide;

FIG. 14 is a perspective view showing a state in which the moving device of the camera is viewed from another direction before the small size guide is attached to the side guide;

FIG. 15 is a cross-sectional view showing the moving device of the camera before attaching the small size guide to the side guide;

FIG. 16 is a perspective view showing the moving device of the camera after attaching the small size guide to the side guide;

FIG. 17 is a cross-sectional view showing a state in which the moving device of the camera is viewed from another direction after attaching the small size guide to the side guide;

FIG. 18 is a cross-sectional view showing the moving device of the camera and the conversion lens after attaching the small size guide to the side guide; and

FIG. 19 is a diagram showing a focus range of a camera when a small size guide is attached to a side guide of a medium accommodating device of a comparative example.

### DETAILED DESCRIPTION

Hereinafter, exemplary embodiments for carrying out the present invention will be described. In the following description, a direction indicated by arrow X in the drawings is defined as an apparatus width direction, and a direction indicated by arrow Y is defined as an apparatus height direction. In addition, a direction (arrow Z direction) orthogonal to each of the apparatus width direction and the apparatus height direction is defined as an apparatus depth direction.

### First Exemplary Embodiment

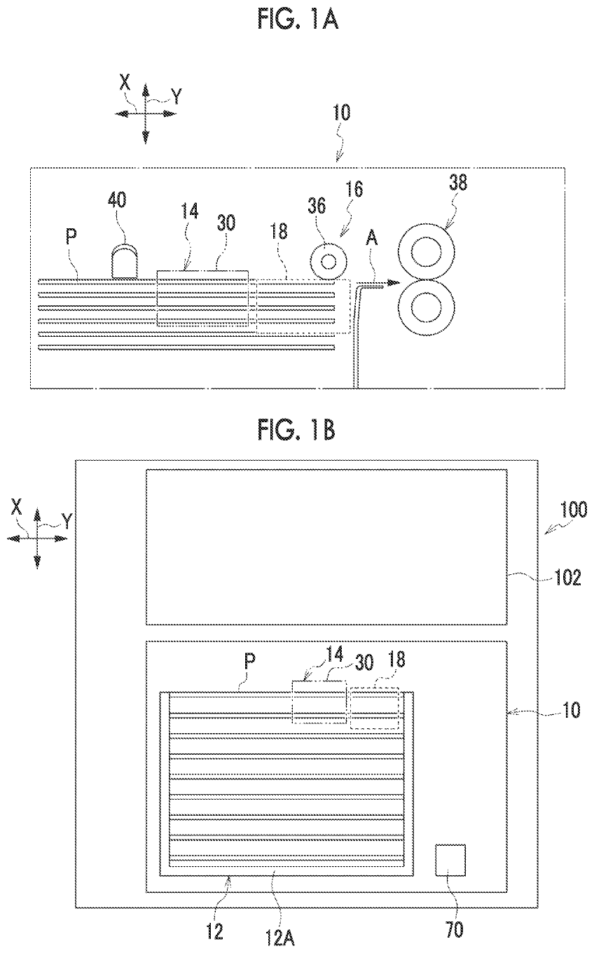

FIG. 1A shows a part of a medium accommodating device 10 according to a first exemplary embodiment, and FIG. 1B shows an example of an image forming system 100 including the medium accommodating device 10.

### Configuration of Image Forming System

As shown in FIG. 1B, the image forming system 100 includes an image forming unit 102 that forms an image on a sheet P as an example of a medium, and the medium accommodating device 10 that accommodates the sheet P to be supplied to the image forming unit 102. Although not shown, the image forming system 100 is provided with a transporting unit that transports sheets P accommodated in the medium accommodating device 10 one by one to be supplied to an image forming position in the image forming unit 102. A configuration and arrangement of the image forming unit 102 and a configuration and arrangement of the transporting unit are not particularly limited. In addition, the medium accommodating device 10 may be optionally configured to be attached to an image forming unit body of the image forming system.

### Configuration of Medium Accommodating Device

### Overall Configuration

As shown in FIGS. 1A and 1B, the medium accommodating device 10 includes a loading unit 12 on which the sheets P can be loaded in an up-down direction and an air supply unit 14 that supplies air to a plurality of sheets P loaded on the loading unit 12 to be floated and separated. In addition, the medium accommodating device 10 includes a transporting unit 16 that sequentially sends the sheets P that have been floated and separated by the air supply unit 14, and a camera 18 as an example of a photographing unit that photographs a state in which the sheets P are floated and separated by the air supply unit 14. In addition, the medium accommodating device 10 includes a control unit 70 that controls an operation of each unit. The control unit 70 is an example of a processor.

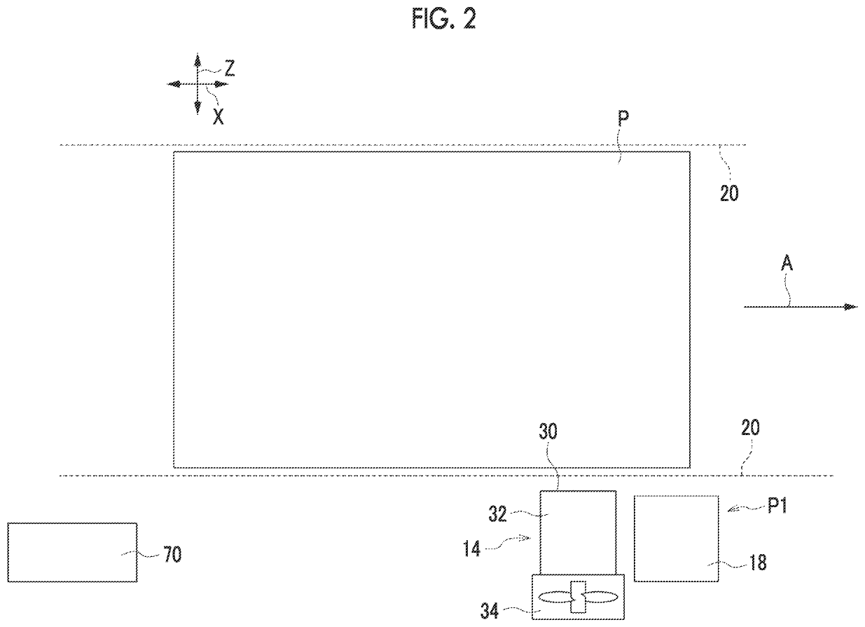

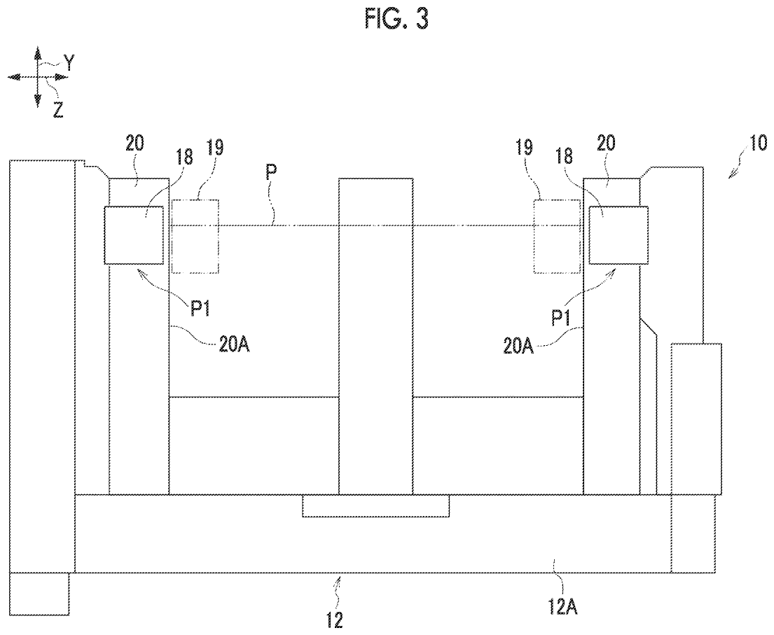

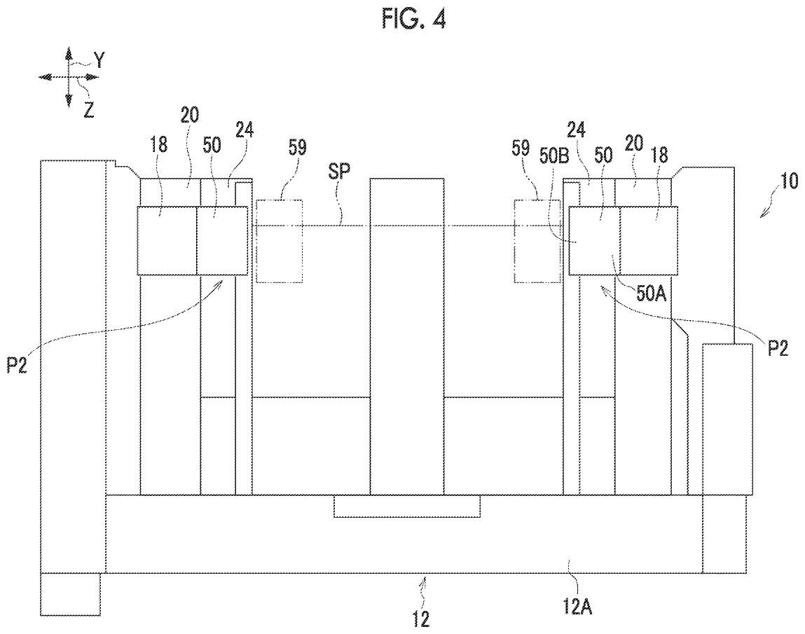

As shown in FIGS. 2 and 3, the medium accommodating device 10 includes side guides 20 that restrict positions of side portions of the sheets P in a width direction (in this example, the arrow Z direction) loaded on the loading unit 12. In addition, as shown in FIG. 4, the medium accommodating device 10 includes a small size guide 24 which is attached to the loading unit 12 when a small size sheet SP having smaller dimensions in the width direction (arrow Z direction) than the sheet P is loaded. Furthermore, the medium accommodating device 10 includes a conversion lens 50 that is installed at a position facing the camera 18 in a state in which the small size guide 24 is attached. The side guide 20 is an example of a first restricting unit. The small size guide 24 is an example of a second restricting unit, and is also called a small size kit. The small size sheet SP is an example of a narrow medium. The conversion lens 50 is an example of a focal distance changing unit.

The sheet P is an example of a sheet of a normal size. The sheet of the normal size is a general size sheet that is usually used in the image forming system 100, and includes sheets of different sizes such as A4, B4, and A3. The small size sheet SP is a sheet having a width smaller than an interval between right and left side guides 20 when the right and left side guides 20 are closest to each other. A lower limit of the width (width in the arrow Z direction) of the small size sheet SP is, for example, preferably wider than a sticking unit 40 by the transporting unit 16. The reason is to prevent the small size sheet SP from being unable to stick due to air leakage from the sticking unit 40. As an example, the sheet P is a sheet having a length in a sheet width direction along the apparatus depth direction (arrow Z direction) equal to or larger than a length of B5 size in a short side. In addition, as an example, the small size sheet SP is a sheet having a length in the sheet width direction along the apparatus depth direction (arrow Z direction) smaller than the length of B5 size in the short side. The sizes of the sheet P and the small size sheet SP can be changed.

### Loading Unit

As shown in FIG. 1B, the loading unit 12 includes a plate-shaped body 12A on which the plurality of sheets P can be loaded. Although not shown, the medium accommodating device 10 includes an elevating device that raises and lowers the plate-shaped body 12A in the up-down direction. The elevating device raises the plate-shaped body 12A so that a position of an uppermost sheet P of the sheets P loaded on an upper side of the plate-shaped body 12A reaches a predetermined height.

### Air Supply Unit

As shown in FIGS. 1A and 2, the air supply unit 14 includes an air outlet 30 through which air is blown toward an upper side of the loading unit 12 in a direction from the side portion of the sheet P in the width direction (arrow Z direction). The air outlet 30 is arranged at a position facing an upper portion of the plurality of sheets P loaded on the upper side of the plate-shaped body 12A. The air supply unit 14 blows air from the air outlet 30 between the plurality of sheets P to float and separate the plurality of sheets P loaded on the plate-shaped body 12A of the loading unit 12.

The air supply unit 14 includes a duct 32 connected to the air outlet 30 and a fan 34 provided upstream of the duct 32 in an air flow direction (see FIG. 2). In the air supply unit 14, air is supplied to the air outlet 30 through the duct 32 by rotation of the fan 34, and air is blown out from the air outlet 30 to the upper side of the loading unit 12.

Although not shown, the air outlets 30 are provided on both sides of the side portions of the sheets P in the width direction (arrow Z direction). The duct 32 is branched into two portions on a side downstream of the fan 34 in the air flow direction, and the air outlet 30 is provided at each downstream end portion of the branched portion of the duct 32.

### Transporting Unit

As shown in FIG. 1A, the transporting unit 16 transports the sheets P loaded on the upper side of the plate-shaped body 12A of the loading unit 12 one by one in an arrow A direction, that is, toward a right side in the apparatus width direction (right side in an arrow X direction). The transporting unit 16 includes a sending roll (feeding roll) 36 that sends the uppermost sheet P on the upper side of the loading unit 12 one by one. In addition, as an example, the transporting unit 16 includes the sticking unit 40 arranged on an inner side (left side in the arrow X direction) in the apparatus width direction with respect to the sending roll 36, and the sticking unit 40 causes the uppermost sheet P to stick to the sticking unit 40. Furthermore, the transporting unit 16 includes a pair of transporting rolls 38 that transport the sheet P sent by the sending roll 36.

As an example, in the transporting unit 16, in a case where the sheet P caused to stick to the sticking unit 40 comes into contact with the sending roll 36, the sheet P is sent from the sending roll 36 in the arrow A direction, and is transported in the arrow A direction by the transporting rolls 38.

### Camera

The camera 18 photographs a floated and separated state of end portions of the sheets P or the small size sheets SP. As shown in FIGS. 2 and 3, the camera 18 is provided on a side of the side portions of the sheets P in the width direction (arrow Z direction). Accordingly, the camera 18 photographs the state in which the sheets P are floated and separated from an outside of the sheets in the width direction in order to detect the floated and separated state of the sheets P. As an example, the cameras 18 are provided on both sides of the side portions of the sheets P in the width direction (arrow Z direction).

As an example, the camera 18 is provided on an upper side of the side guide 20. As an example, the camera 18 is attached to the upper side of the side guide 20 via a bracket, but a configuration of an attachment member for attaching the camera 18 to the upper side of the side guide 20 is not particularly limited. That is, the camera 18 may be fixed to the upper side of the side guide 20. Accordingly, when the side guide 20 slides in the apparatus depth direction (arrow Z direction), which will be described later, according to a size of the sheet P, the camera 18 slides integrally with the side guide 20 in the apparatus depth direction (arrow Z direction). In addition, the camera 18 is arranged near an end portion on a downstream side in a sending direction (arrow A direction) of the sheet P in the side guide 20.

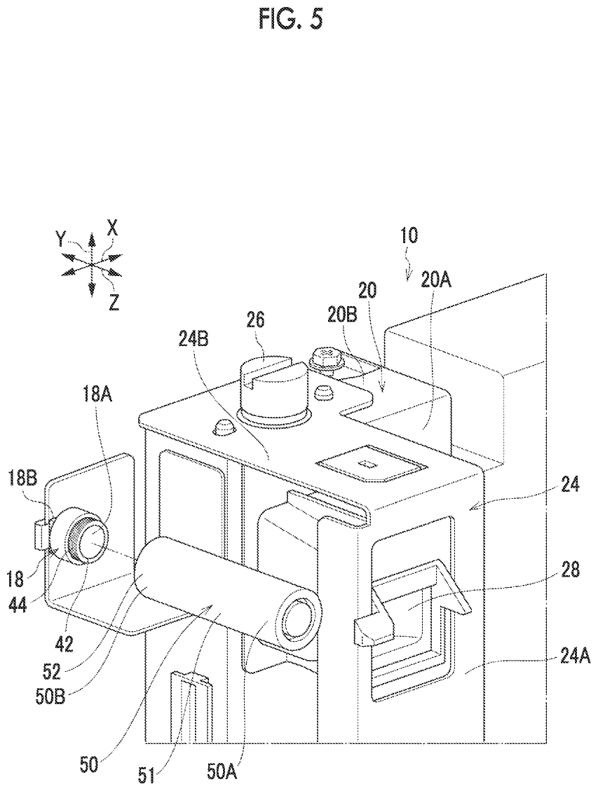

As an example, the camera 18 includes a circular lens portion 18A arranged on a front surface of a case 18B (a surface on a plate-shaped body 12A side of the loading unit 12) (see FIG. 5). The lens portion 18A of the camera 18 is a photographing side.

As shown in FIG. 3, at a normal position P1 at which the position of the sheet P of the normal size is restricted by the side guide 20, the camera 18 is arranged at a position facing the side portions of the sheets Pin the width direction (arrow Z direction) loaded on the plate-shaped body 12A. At the normal position P1, a vicinity of an end portion of the sheet P in the width direction loaded on the plate-shaped body 12A falls within a focus range 19, which is a range in which a focal position (that is, focus) of the camera 18 is aligned. Accordingly, the camera 18 can photograph the end portion of the sheet P of the normal size in the width direction more clearly at the normal position P1. That is, the focus range 19 is a range in which the end portion of the sheet P in the width direction (the arrow Z direction) can be clearly photographed by the camera 18 at the normal position P1, and is a range in which the end portion of the sheet P in the width direction (the arrow Z direction) can be detected based on a photographed image.

Although not shown, an illumination unit that irradiates an end portion side of the sheet P in the width direction (the arrow Z direction) with light in a case where the sheet P is photographed by the camera 18 is provided on an upper side or a lower side of the camera 18. The number illumination units and positions thereof are not particularly limited.

### Side Guide

As shown in FIG. 3, the side guide 20 is provided on the upper side of the loading unit 12. The side guides 20 are provided on both sides of the side portions of the sheets P in the width direction (arrow Z direction). As an example, the side guide 20 is slidably attached to the loading unit 12 in the apparatus depth direction (arrow Z direction). The side guide 20 can be slid in the apparatus depth direction (arrow Z direction) according to the size of the sheet P. A movement range of the side guide 20 is limited by a stopper (length of a guide slit) or the like (not shown) so as not to interfere with the transporting unit 16. Although not shown, the side guide 20 is provided with the air outlet 30 and the duct 32 of the air supply unit 14.

As shown in FIG. 3, the side guide 20 includes a vertical wall 20A arranged on an inner side in the apparatus depth direction (arrow Z direction) along the up-down direction. The vertical wall 20A restricts a position of the side portion of the sheet P in the width direction loaded on the plate-shaped body 12A of the loading unit 12.

### Small Size Guide

As shown in FIG. 4, the small size guide 24 restricts a position of a side portion of the small size sheet SP in the width direction (arrow Z direction) loaded on the plate-shaped body 12A of the loading unit 12. The small size guide 24 is directly or indirectly attached to the loading unit 12. As an example, the small size guide 24 is attached to the upper side of the loading unit 12 via the side guide 20. The small size guides 24 are attached to both sides of the small size sheet SP in the width direction (arrow Z direction). As an example, the small size guide 24 is detachably attached to the side guide 20 from an upper side of the side guide 20.

As shown in FIG. 5, the small size guide 24 includes a vertical wall 24A arranged on the inner side in the apparatus depth direction (arrow Z direction) along the up-down direction, and an upper wall 24B extending outward from an upper end portion of the vertical wall 24A in the apparatus depth direction (arrow Z direction). When the small size guide 24 is attached to the side guide 20, the upper wall 24B of the small size guide 24 is arranged to come into contact with an upper wall 20B of the side guide 20. In this state, the upper wall 24B is fixed to the upper wall 20B of the side guide 20 by an attachment tool 26 from a small size guide 24 side, whereby the small size guide 24 is attached to the side guide 20.

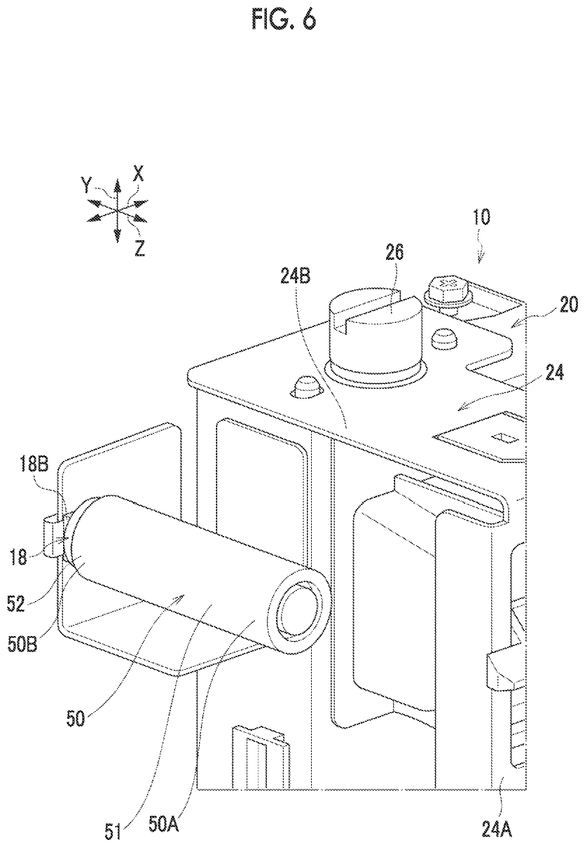

The vertical wall 24A is provided at a position that does not interfere with the photographing side of the lens portion 18A of the camera 18 in the state in which the small size guide 24 is attached to the side guide 20. In addition, the vertical wall 24A is provided at a position that does not interfere with the conversion lens 50 when the conversion lens 50 is attached to the lens portion 18A of the camera 18 (see FIG. 6). Although not shown, the small size guide 24 is provided at a position that does not interfere with a light irradiation direction of the illumination unit.

The small size guide 24 is provided with a tubular air outlet portion 28 for passing the air from the air outlet 30 at a position facing the air outlet 30. In order to facilitate understand the attachment position of the small size guide 24 to the side guide 20, a recessed portion in which the small size guide 24 is fitted may be provided in the upper wall 20B of the side guide 20.

### Conversion Lens

As shown in FIG. 5, the conversion lens 50 is installed at a position facing the lens portion 18A of the camera 18, and has a function of aligning a focal point of the camera 18 with the side portion of the small size sheet SP in the width direction (arrow Z direction) by changing a focal distance. In the first exemplary embodiment, the conversion lens 50 is installed at the position facing the lens portion 18A of the camera 18 in the state in which the small size guide 24 is attached to the side guide 20. The vertical wall 24A of the small size guide 24 is not provided on the photographing side (that is, the side on which the small size sheet SP is loaded) which is one end portion 50A of the conversion lens 50 in an axial direction. The conversion lens 50 is arranged at a position overlapping a part of the small size guide 24 in the apparatus width direction (arrow X direction).

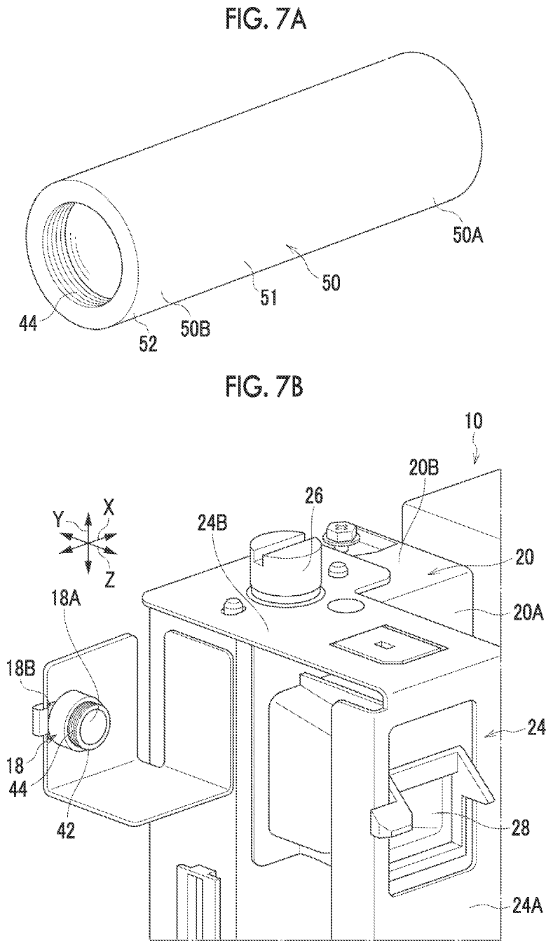

In the first exemplary embodiment, the conversion lens 50 is configured to be manually attached by a user to a bracket 42 on an outer peripheral side of the lens portion 18A of the camera 18. As shown in FIG. 7A, the other end portion 50B (a side of the position facing the camera 18) of the conversion lens 50 in the axial direction has a tubular portion 52 extending in the axial direction from an outer peripheral portion 51 of the conversion lens 50, and an inner peripheral surface of the tubular portion 52 is provided with a female thread portion 54.

As shown in FIG. 7B, the bracket 42 is provided on the outer peripheral side of the lens portion 18A of the camera 18. The bracket 42 is provided with a small diameter portion having an outer diameter smaller than a center portion at a tip portion in the axial direction, and the small diameter portion is provided with a male thread portion 44 with which the female thread portion 54 can mesh (that is, be tightened). As shown in FIG. 6, the conversion lens 50 is attached to the bracket 42 of the camera 18 by tightening the female thread portion 54 of the conversion lens 50 to the male thread portion 44 of the camera 18.

As an example, the user attaches the small size guide 24 to the side guide 20 and attaches the conversion lens 50 to the bracket 42 of the camera 18. There is no limitation on an attachment order of the small size guide 24 and the conversion lens 50. For example, the conversion lens 50 may be attached to the bracket 42 of the camera 18 after the small size guide 24 is attached to the side guide 20. Alternatively, for example, the small size guide 24 may be attached to the side guide 20 after the conversion lens 50 is attached to the bracket 42 of the camera 18.

As shown in FIG. 4, the other end portion 50B (end portion on a side opposite to the camera 18) of the conversion lens 50 in the axial direction is arranged at a position facing the side portion of the small size sheet SP in the width direction (arrow Z direction) loaded on the plate-shaped body 12A. That is, at a change position P2 at which the position of the small size sheet SP is restricted by the small size guide 24, one end portion 50A of the conversion lens 50 in the axial direction is arranged at the position facing the side portion of the small size sheet SP in the width direction (arrow Z direction) loaded on the plate-shaped body 12A. By changing the focal distance with the conversion lens 50, the focal point of the camera 18 can be aligned with the side portion of the small size sheet SP in the width direction (arrow Z direction). That is, at the change position P2, a vicinity of an end portion of the small size sheet SP in the width direction loaded on the plate-shaped body 12A falls within the focus range 59, which is the range in which the focal position (that is, focus) of the camera 18 changed by the conversion lens 50 is aligned. Accordingly, the camera 18 can photograph the end portion of the small size sheet SP in the width direction more clearly at the change position P2. That is, the focus range 59 is a range in which the end portion of the small size sheet SP in the width direction (arrow Z direction) can be clearly photographed by the camera 18 at the change position P2, and is a range in which the end portion of the small size sheet SP in the width direction can be detected based on a photographed image.

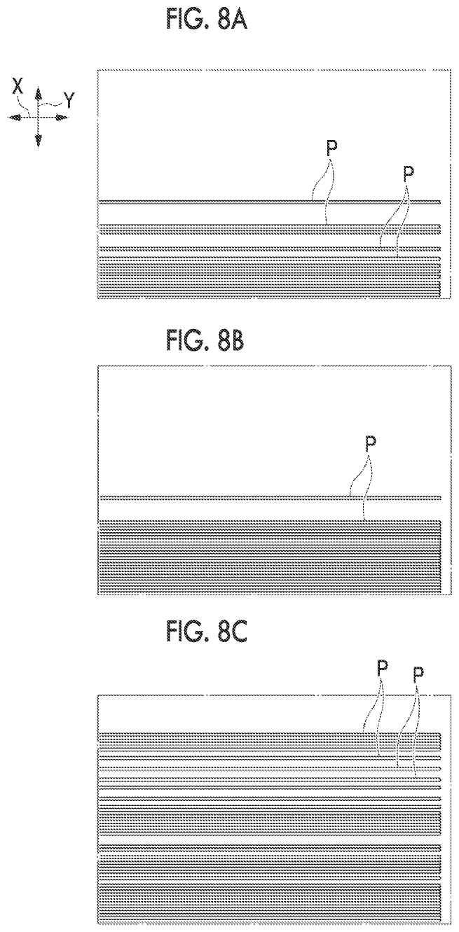

FIGS. 8A to 8C show examples of a state of the sheets P detected by the camera 18 when air is blown from the air outlet 30 of the air supply unit 14 toward the sheets P loaded on the plate-shaped body 12A of the loading unit 12. In a first example shown in the FIG. 8A, about 10 sheets P on an upper portion side are independently separated and floated, so that the floated and separated state of the sheets P is good. In this state, even in a case where the sheets P are sequentially transported by the transporting unit 16, a double feed of the sheets P or the like is less likely to occur.

In a second example shown in FIG. 8B, the number of sheets P floated is only about one, and the floated and separated state of the sheets P is insufficient. In this state, in a case where the sheets P are sequentially transported by the transporting unit 16, there is a possibility of a supply failure (that is, misfeed) in which the sheets P are not smoothly supplied.

In a third example shown in FIG. 8C, since air is blown too strongly from the air outlet 30, the sheets P on the upper portion side are in a bundle and are floated, so that the floated and separated state of the sheets P is insufficient. In this state, in a case where the sheets P are sequentially transported by the transporting unit 16, there is a possibility of a double feed of the sheets P.

The control unit 70 changes the amount of the air supplied by controlling rotation of the fan 34 of the air supply unit 14 based on the state of the sheets P photographed by the camera 18. As an example, in the state shown in FIG. 8B, the control unit 70 increases a rotation frequency of the fan 34 of the air supply unit 14 per unit time to increase the amount of air supplied. In addition, as an example, in the state shown in FIG. 8C, the control unit 70 decreases the rotation frequency of the fan 34 of the air supply unit 14 per unit time to decrease the amount of air supplied. Accordingly, the floated and separated state of the sheets P is adjusted.

### Actions and Effects

Next, actions and effects of the present exemplary embodiment will be described.

In the medium accommodating device 10, for the plurality of sheets P of the normal size loaded on the plate-shaped body 12A of the loading unit 12, the positions of the end portions of the sheets P in the width direction (arrow Z direction) are restricted by the side guide 20. In this state, as the air is blown from the air outlet 30 of the air supply unit 14, the plurality of sheets P loaded on the plate-shaped body 12A of the loading unit 12 are floated and separated.

At the normal position P1 at which the positions of the sheets P of the normal size are restricted by the side guide 20, the camera 18 is arranged at the position facing the side portions of the sheets P in the width direction (arrow Z direction) loaded on the plate-shaped body 12A. At the normal position P1, the vicinity of the end portion of the sheet P in the width direction loaded on the plate-shaped body 12A falls within the focus range 19, which is a range in which the focal position (that is, focus) of the camera 18 is aligned (see FIG. 3). Accordingly, the camera 18 can photograph the end portion of the sheet P of the normal size in the width direction more clearly at the normal position P1. Therefore, the state in which the sheets P loaded on the plate-shaped body 12A of the loading unit 12 are floated and separated can be photographed by the camera 18 from the outside of the sheets P in the width direction.

In addition, in a case of using the small size sheet SP having dimensions in the width direction smaller than the sheet P of the normal size, the small size guide 24 is attached to the side guide 20 (see FIG. 5). At the same time, the conversion lens 50 is attached to the bracket 42 of the camera 18 by tightening the female thread portion 54 of the conversion lens 50 to the male thread portion 44 of the bracket 42 of the camera 18.

At the change position P2 at which the position of the small size sheet SP is restricted by the small size guide 24, one end portion 50A (end portion on the side opposite to the camera 18) of the conversion lens 50 in the axial direction is arranged at the position facing the side portion of the small size sheet SP in the width direction (arrow Z direction) loaded on the plate-shaped body 12A (see FIG. 4). At the change position P2, by changing the focal position with the conversion lens 50, the vicinity of the end portion of the small size sheet SP in the width direction loaded on the plate-shaped body 12A falls within the focus range 59, which is the range in which the focal position (focus) of the camera 18 is aligned. Accordingly, the camera 18 can photograph the end portion of the small size sheet SP in the width direction loaded on the plate-shaped body 12A more clearly at the change position P2.

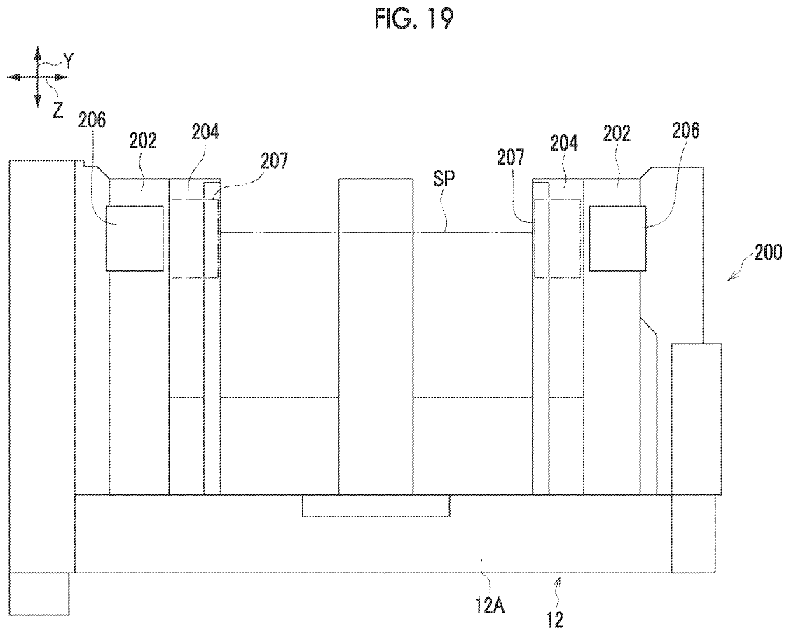

Here, a medium accommodating device 200 of a comparative example will be described with reference to FIG. 19. As shown in FIG. 19, in the medium accommodating device 200, a position of a camera 206 does not change when a small size guide 204 is attached to a side guide 202. In this state, there are cases where the end portion of the small size sheet SP in the width direction loaded on the plate-shaped body 12A of the loading unit 12 does fall within a focus range 207 of the camera 206. Therefore, it is difficult for the camera 206 to clearly photograph the end portion of the small size sheet SP in the width direction. Therefore, it is difficult to accurately detect the end portion of the small size sheet SP in the width direction based on a photographed image.

Contrary to this, in the medium accommodating device 10 of the first exemplary embodiment, when the small size guide 24 is attached to the side guide 20, by tightening the female thread portion 54 of the conversion lens 50 to the male thread portion 44 of the bracket 42 of the camera 18, the conversion lens 50 is attached to the bracket 42 of the camera 18.

Therefore, in the medium accommodating device 10, compared to a case where the focal position of the camera does not change when the small size guide that restricts the position of the side portion of the small size sheet SP in the width direction, which has smaller dimensions in the width direction than the sheet P, is attached, the floated and separated state of the small size sheet SP may be accurately photographed.

In addition, in the medium accommodating device 10, the camera 18 is provided in the side guide 20, and the small size guide 24 is detachably attached to the side guide 20. Therefore, in the medium accommodating device 10, compared to a case where the camera is provided in the loading unit other than the side guide, the floated and separated state of the sheet P of the normal size may be accurately photographed in a state in which the small size guide 24 is not attached.

In addition, in the medium accommodating device 10, the small size guides 24 are attached to both sides of the small size sheet SP in the width direction (arrow Z direction), and the cameras 18 are respectively provided on both sides of the small size sheet SP in the width direction. Therefore, in the medium accommodating device 10, compared to a case where the camera is provided on one side of the small size sheet in the width direction, the floated and separated state of the small size sheet SP may be easily photographed.

In addition, the medium accommodating device 10 includes the control unit 70 provided with a processor, and the control unit 70 changes the amount of air supplied by the air supply unit 14 based on an image photographed by the camera 18. Therefore, in the medium accommodating device 10, compared to a case where the amount of air supplied is not changed, clogging or a double feed of the sheets P and the small size sheets SP may be suppressed.

In addition, the image forming system 100 includes the medium accommodating device 10 and the image forming unit 102 that forms an image on the sheet P sent from the medium accommodating device 10. Therefore, in the image forming system 100, compared to a case where the focal position of the camera does not change when the small size guide 24 that restricts the position of the side portion of the small size sheet SP in the width direction, which has smaller dimensions in the width direction than the sheet P, is attached, a failure in sending of the small size sheet SP from the medium accommodating device 10 to the image forming unit 102 may be suppressed.

### Second Exemplary Embodiment

Next, a medium accommodating device of a second exemplary embodiment will be described. It should be noted that the identical reference numerals are assigned to the identical configuration parts to the first exemplary embodiment described above, and the description thereof will be omitted as appropriate.

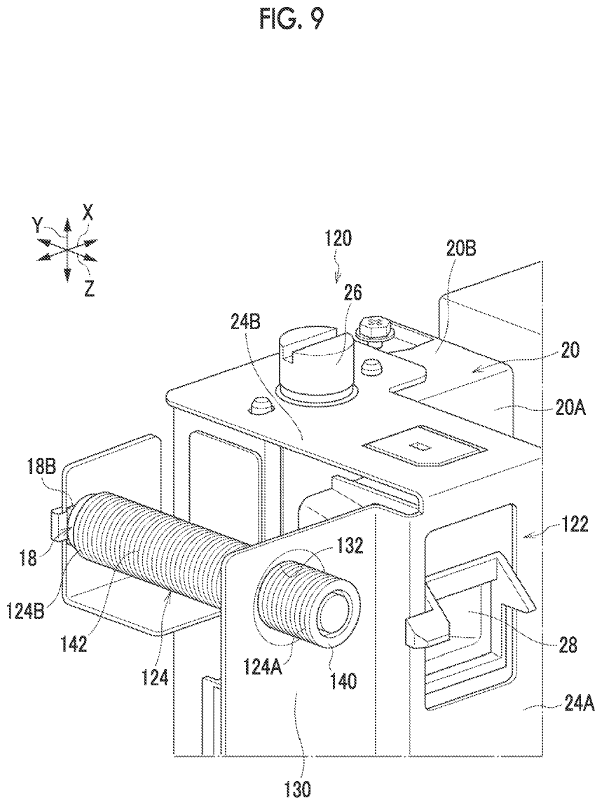

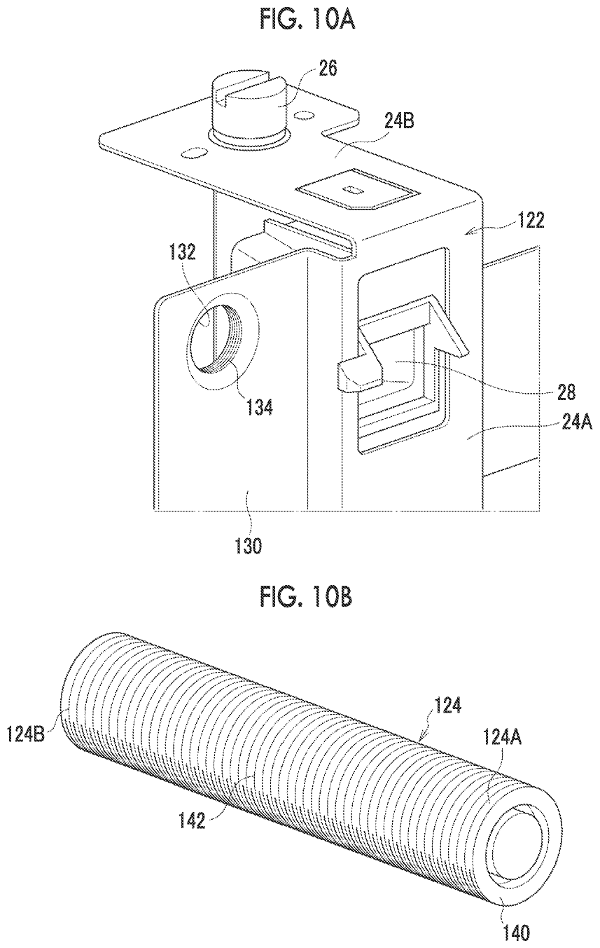

As shown in FIGS. 9, 10A, and 10B, a medium accommodating device 120 of the second exemplary embodiment is different in configurations of a small size guide 122 and a conversion lens 124 from the medium accommodating device 10 of the first exemplary embodiment. The small size guide 122 is an example of the second restricting unit, and is also referred to as a small size kit. The conversion lens 124 is an example of the focal distance changing unit.

The conversion lens 124 is attached to the small size guide 122 so that a position with respect to the camera 18 can be adjusted. Specifically, as shown in FIGS. 9 and 10A, the small size guide 122 includes a plate-shaped portion 130 extending toward a front side (loading unit 12 side) of the camera 18 in a state of being attached to the side guide 20. The plate-shaped portion 130 is provided with a circular opening portion 132 through which the conversion lens 124 passes, and a female thread portion 134 is formed at an inner peripheral portion of the opening portion 132 (see FIG. 10A).

As shown in FIGS. 9 and 10B, an outer periphery of a cylindrical case 140 of the conversion lens 124 is provided with a male thread portion 142 that meshes with the female thread portion 134 and allows the conversion lens 124 to move in an axial direction. The position of the conversion lens 124 with respect to the camera 18 can be adjusted by rotating the conversion lens 124 in a state in which the male thread portion 142 of the conversion lens 124 meshes with the female thread portion 134 of the plate-shaped portion 130.

As an example, when the small size guide 122 is attached to the side guide 20, a state in which the female thread portion 134 of the plate-shaped portion 130 meshes with the male thread portion 142 of the conversion lens 124 is set in advance. Then, after attaching the small size guide 122 to the side guide 20, the position of the conversion lens 124 with respect to the camera 18 is adjusted by rotating the conversion lens 124. Accordingly, the conversion lens 124 is installed at a position facing the lens portion of the camera 18 in a state in which the small size guide 122 is attached to the side guide 20 (see FIG. 9). As an example, by rotating the conversion lens 124, the other end portion 124B (end portion on the camera 18 side) on a side opposite to one end portion 124A in of the conversion lens 124 the axial direction is brought into contact with the lens portion of the camera 18. One end portion 124A of the conversion lens 124 in the axial direction is arranged at a position facing the side portion of the small size sheet SP (see FIG. 4) in the width direction (arrow Z direction) loaded on the plate-shaped body 12A of the loading unit 12. By changing a focal distance of the conversion lens 124, the focal point of the camera 18 can be aligned with the side portion of the small size sheet SP (see FIG. 4) in the width direction (arrow Z direction).

The medium accommodating device 120 of the second exemplary embodiment has the following actions and effects in addition to the actions and effects of the same configuration as the medium accommodating device 10 of the first exemplary embodiment.

In the medium accommodating device 120, the conversion lens 124 is attached to the small size guide 122 so that the position with respect to the camera 18 can be adjusted. Therefore, in the medium accommodating device 120, compared to a case where the user directly attaches the conversion lens to the camera 18 by an operation different from the attachment of the small size guide, time and effort required for the user to attach the conversion lens 124 may be reduced.

In addition, the outer periphery of the case 140 of the conversion lens 124 is provided with the male thread portion 142 that meshes with the female thread portion 134 of the small size guide 122 and allows the conversion lens 124 to move in the axial direction. Therefore, in the medium accommodating device 120, compared to a case where the conversion lens is moved in the axial direction with respect to the small size guide by an attachment tool different from the conversion lens, the number of parts for adjusting the position of the conversion lens 124 may be reduced.

### Third Exemplary Embodiment

Next, a medium accommodating device of a third exemplary embodiment will be described. It should be noted that the identical reference numerals are assigned to the identical configuration parts to the first and second exemplary embodiments described above, and the description thereof will be omitted as appropriate.

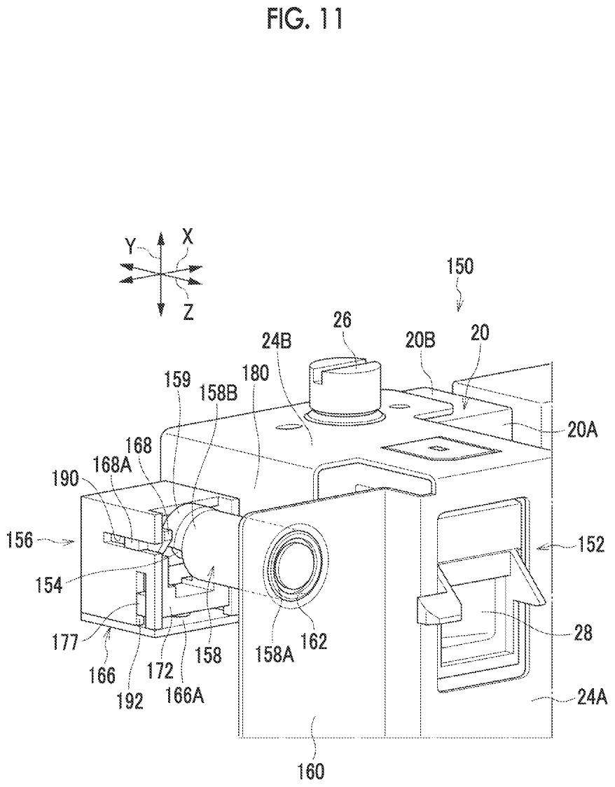

As shown in FIGS. 11 to 18, a medium accommodating device 150 of a third exemplary embodiment is different in configurations of a small size guide 152 and a conversion lens 158 from the medium accommodating device 10 of the first exemplary embodiment. Furthermore, the medium accommodating device 150 is different from the medium accommodating device 10 of the first exemplary embodiment in that the medium accommodating device 150 includes a moving device 156 for moving a camera 154. The small size guide 152 is an example of the second restricting unit. The camera 154 is an example of the photographing unit, and the moving device 156 is an example of a moving unit.

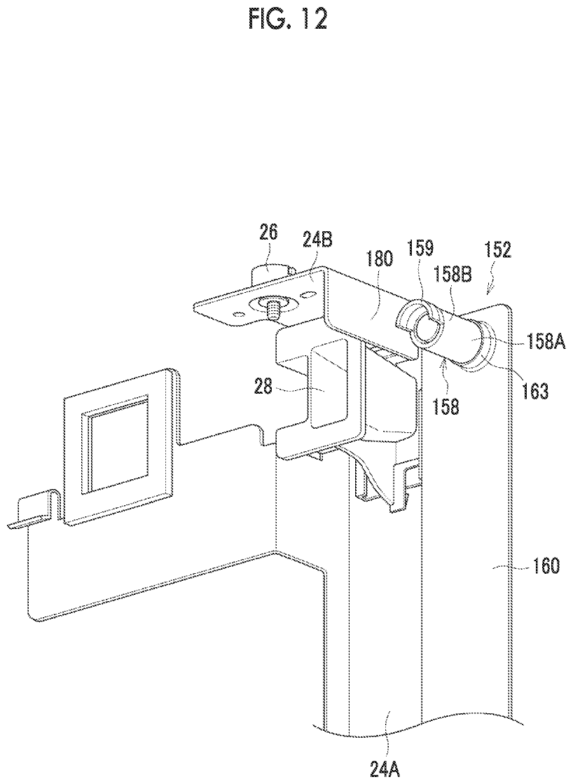

As shown in FIGS. 11 and 12, the small size guide 152 includes a plate-shaped portion 160 extending toward a front side (loading unit 12 side) of the camera 154 in a state of being attached to the side guide 20. The plate-shaped portion 160 is provided with a circular opening portion 162, and one end portion 158A (one end portion on a small size sheet SP side) of the conversion lens 158 in an axial direction is attached to an edge portion of the opening portion 162. One end portion 158A of the conversion lens 158 in the axial direction is joined to a tubular portion 163 extending from the edge portion of the opening portion 162 of the plate-shaped portion 160 (see FIG. 12), and the conversion lens 158 does not move with respect to the plate-shaped portion 160 in the axial direction.

The other end portion 158B of the conversion lens 158 in the axial direction is provided with a protruding portion 159 extending in the axial direction. The protruding portion 159 is provided on a part of an outer peripheral surface of the conversion lens 158. The protruding portion 159 is curved along an outer peripheral surface of a lens portion 154A of the camera 154, and can come into contact with the outer peripheral surface of the lens portion 154A.

In addition, the small size guide 152 is provided with a plate-shaped piece 180 extending downward from the upper wall 24B. The plate-shaped piece 180 is arranged on a vertical wall 24A side with respect to the plate-shaped portion 160, and is provided along the conversion lens 158 at an interval from the conversion lens 158.

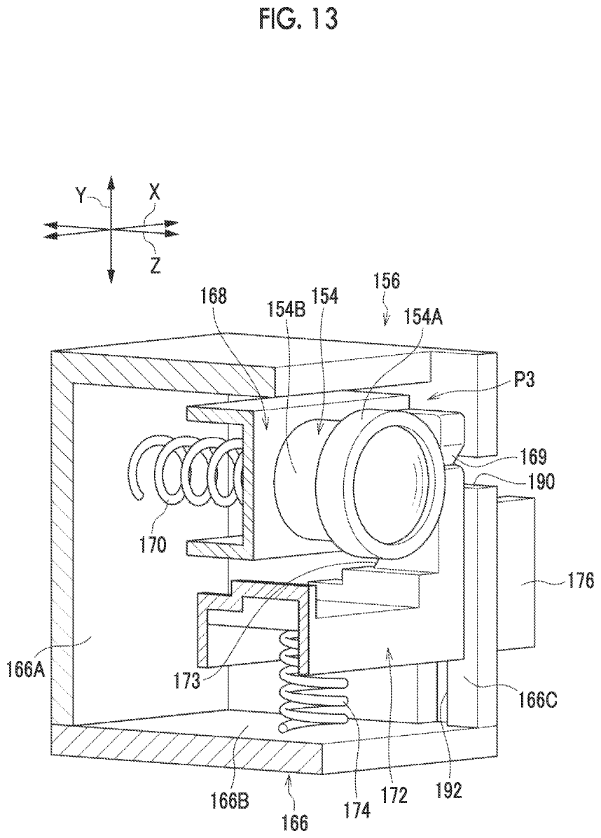

As shown in FIGS. 13 to 15, the camera 154 includes a case 154B and a lens portion 154A provided on a surface of the case 154B on the loading unit 12 (see FIG. 4) side. The camera 154 is provided in the moving device 156, and a housing 166 of the moving device 156, which will be described later, is attached to the side guide 20. A lens portion 154A side of the camera 154 is provided on a side on which the plate-shaped portion 160 of the small size guide 152 is arranged when the small size guide 152 is attached to the side guide 20.

The moving device 156 has a function of moving the camera 154 to a position facing the conversion lens 158 in conjunction with the attachment of the small size guide 152 when the small size guide 152 is attached to the side guide 20. Specifically, as shown in FIGS. 13 to 15, the moving device 156 includes a rectangular parallelepiped-shaped housing 166 which is open to a conversion lens 158 side, and a support body 168 that is arranged inside the housing 166 and supports the camera 154.

The moving device 156 includes a coil spring 170 as an example of an urging member that urges the support body 168 of the camera 154 to the side of the position facing the conversion lens 158. In addition, the moving device 156 includes a holding portion 172 that holds the camera 154 at a normal position P3 at which the sheet P of the normal size can be photographed against an urging force of the coil spring 170. Furthermore, the moving device 156 includes a coil spring 174 as an example of another urging member that presses the holding portion 172 in a direction toward the support body 168 of the camera 154.

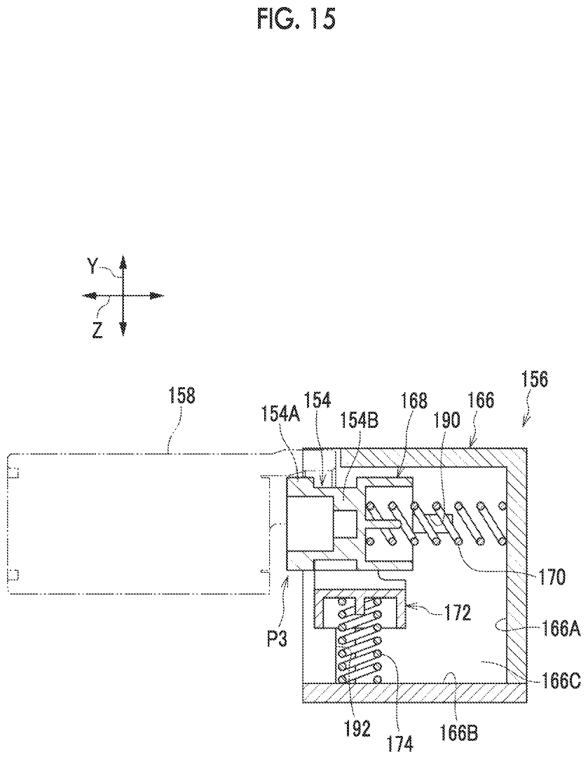

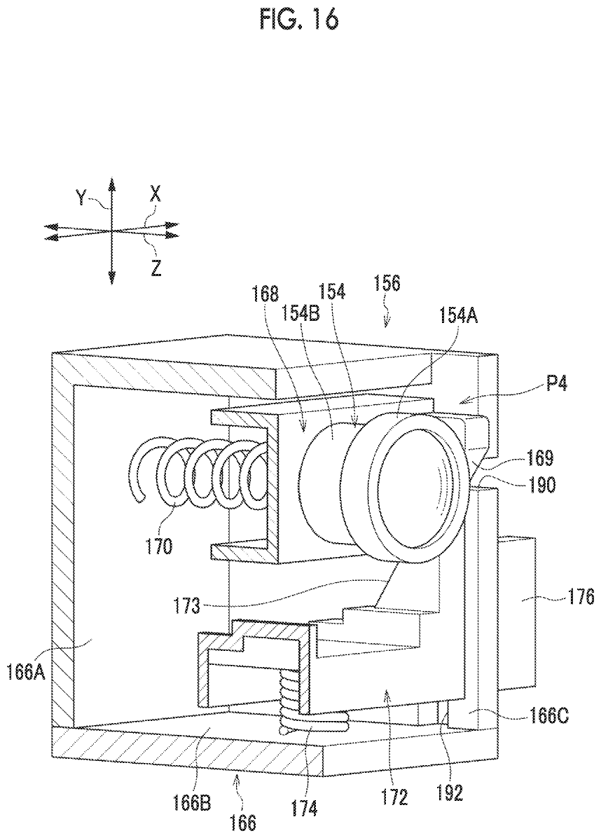

The support body 168 moves the camera 154 between the normal position P3 (see FIGS. 13 to 15) at which the sheet P of the normal size can be photographed and a movement position P4 (see FIGS. 16 to 18) at which the camera 154 faces the conversion lens 158. As an example, the support body 168 is a box body having a recessed U-shaped cross section, and the camera 154 is attached to a surface of the support body 168 on a side on which the support body 168 protrudes. The camera 154 is attached to the support body 168 to be integrated therewith, and moves with the movement of the support body 168. FIG. 15 shows a state of the moving device 156 before the small size guide 152 is attached, in which the camera 154 is arranged at the normal position P3 at which the sheet P of the normal size can be photographed. In addition, in FIG. 15, in order to clarify a positional relationship between the camera 154 arranged at the normal position P3 and other members, a position of the conversion lens 158 when the small size guide 152 is attached is indicated by an imaginary line.

One end of the coil spring 170 in an axial direction is joined to an inside of a wall 166A on a back surface side of the housing 166, and the other end of the coil spring 170 in the axial direction is joined to a surface of the support body 168 opposite to the camera 154 (recessed back side surface) (see FIGS. 13 and 15 and the like).

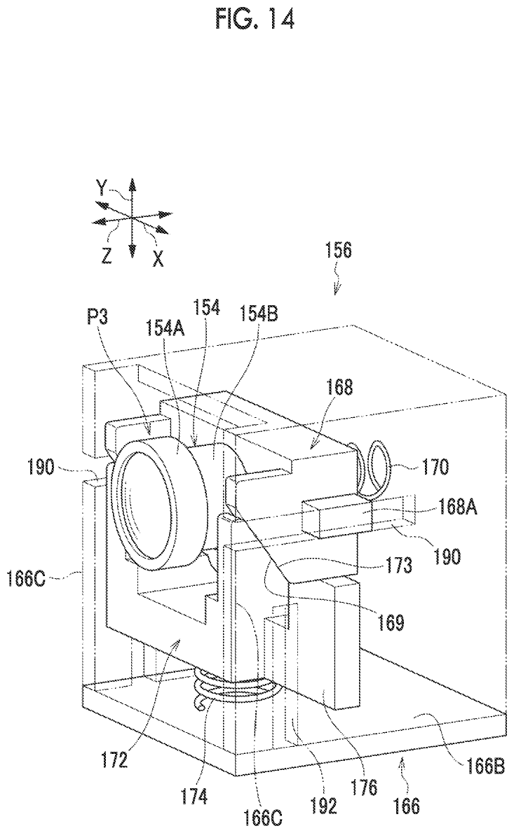

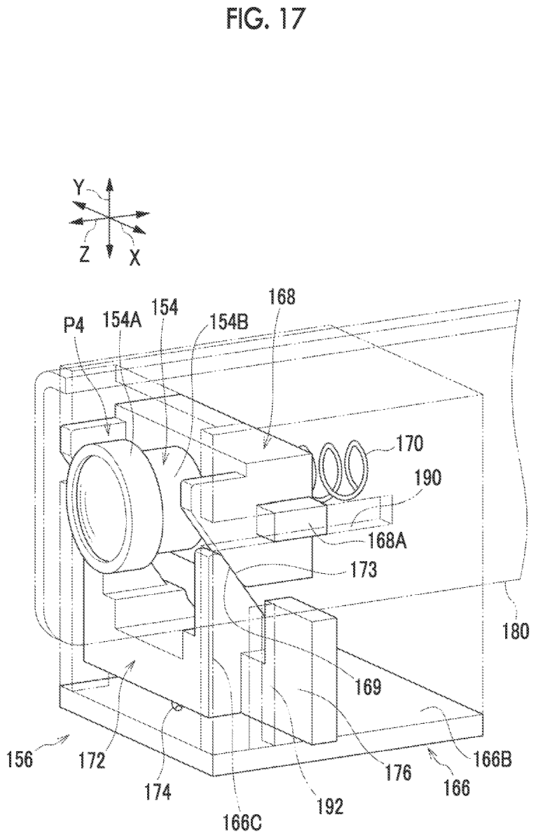

The support body 168 is provided with a first inclined surface 169 arranged in a direction intersecting a direction in which the camera 154 moves from the normal position P3 toward a movement position P4 side (see FIGS. 14 and 17). As an example, the camera 154 is configured to move from the normal position P3 to the movement position P4 along a horizontal direction of the housing 166, and the first inclined surface 169 is arranged in a direction intersecting the horizontal direction of the housing 166. The first inclined surface 169 is formed on a lower surface of the support body 168 in a vertical direction, and is inclined such that a surface on the lens portion 154A side of the camera 154 is on an upper side and a surface on a case 154B side of the camera 154 is on a lower side (see FIGS. 14 and 17).

Slits 190 are formed in upper portions of side walls 166C facing each other in the apparatus width direction (arrow X direction) of the housing 166 along the horizontal direction. Protrusions 168A to be inserted into the slits 190 of the housing 166 are provided on both sides of the support body 168 in the apparatus width direction (arrow X direction) (see FIG. 14). As the protrusions 168A of the support body 168 move while sliding on inner surfaces of the slits 190 of the housing 166, the support body 168 moves in the horizontal direction along the slits 190 of the housing 166. The axial direction of the coil spring 170 is a direction along the slit 190, and the support body 168 moves in a direction along the slit 190 due to the urging force of the coil spring 170.

As shown in FIGS. 14 to 15, the holding portion 172 is arranged on a lower side of the support body 168 in the vertical direction. The holding portion 172 is provided with a second inclined surface 173 that comes into contact with the first inclined surface 169 of the support body 168 (see FIGS. 14 and 17). The second inclined surface 173 is formed on an upper surface of the holding portion 172 in the vertical direction, and is inclined such that a surface on the lens portion 154A side of the camera 154 is on an upper side and a surface on the case 154B side of the camera 154 is on a lower side. That is, the second inclined surface 173 is inclined so as to have an upward gradient in a direction toward the lens portion 154A side of the camera 154.

One end of the coil spring 174 in an axial direction is joined to an inside of a bottom wall 166B on a lower side of the housing 166 in the vertical direction, and the other end of the coil spring 174 in the axial direction is joined to a lower surface of the holding portion 172. The axial direction of the coil spring 174 is a direction along the vertical direction of the housing 166.

The holding portion 172 is pressed in the direction toward the support body 168 of the camera 154 by the force of the coil spring 174, so that the second inclined surface 173 is pressed against the first inclined surface 169 of the support body 168. By the coil spring 174, the second inclined surface 173 of the holding portion 172 is pressed against the first inclined surface 169 of the support body 168, so that the holding portion 172 holds the camera 154 at the normal position P3, at which the sheet P of the normal size can be photographed, against the urging force of the coil spring 170 (see FIG. 14). In the third exemplary embodiment, a spring force of the coil spring 174 is set to be stronger than a spring force of the coil spring 170.

As shown in FIGS. 13, 14, and 17, lower portions of the side walls 166C on both sides of the housing 166 in the apparatus width direction (arrow X direction) are provided with slits 192 formed along the vertical direction. One side portion of the holding portion 172 is provided with a plate-shaped protruding piece 176 extending to an outside of the housing 166 through the slit 192 of the side wall 166C on a small size guide 152 side. In addition, the other side portion of the holding portion 172 is provided with a protrusion 177 to be inserted into the slit 192 of the side wall 166C (see FIG. 11). The axial direction of the coil spring 174 is a direction along the slit 192. In a state in which the holding portion 172 is moved upward by the coil spring 174, the protruding piece 176 extends upward in an L-shape above an upper end of the slit 192 (see FIG. 14).

The holding portion 172 is movable in the up-down direction along the slits 192 in a state in which the protruding piece 176 is inserted into one slit 192 and the protrusion 177 is inserted into the other slit 192.

The small size guide 152 is provided with the plate-shaped pieces 180 as described above (see FIG. 12). The plate-shaped piece 180 is an example of a contact portion. As shown in FIG. 17, when the small size guide 152 is attached to the side guide 20, the plate-shaped piece 180 hits an upper surface of the protruding piece 176 of the holding portion 172, pushes down the protruding piece 176, and compresses the coil spring 174. At this time, as the holding portion 172 moves downward, the holding portion 172 releases holding of the support body 168 of the camera 154 at the normal position P3.

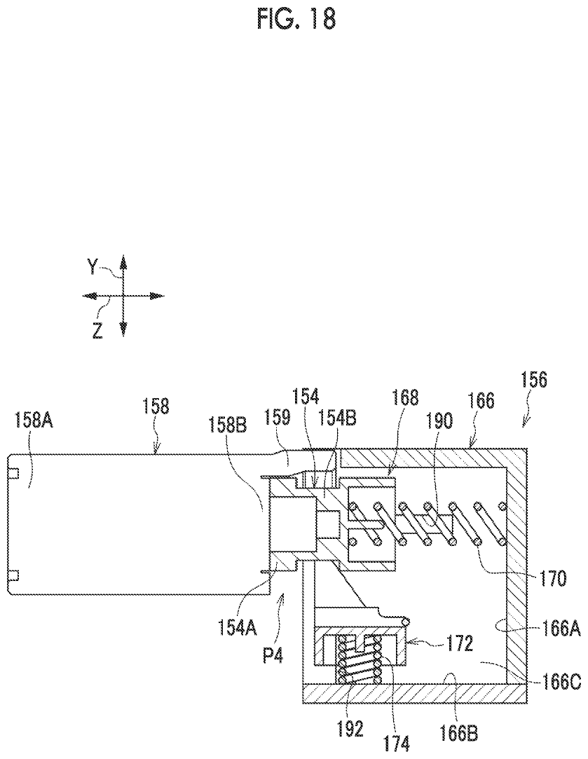

Accordingly, as shown in FIGS. 16 to 18, the support body 168 moves to the conversion lens 158 side while the first inclined surface 169 of the support body 168 slides on the second inclined surface 173 of the holding portion 172 due to the urging force of the coil spring 170. At this time, the support body 168 moves in the horizontal direction in a state in which the protrusion 168A is guided by the inner surface of the slit 190, and the camera 154 supported by the support body 168 moves to the movement position P4 facing the conversion lens 158 (see FIG. 18).

As an example, due to the movement of the camera 154 supported by the support body 168, a front surface of the lens portion 154A of the camera 154 comes into contact with the other end portion 158B of the conversion lens 158 in the axial direction. At this time, the outer peripheral surface of the lens portion 154A comes into contact with the protruding portion 159 of the conversion lens 158, and the lens portion 154A and the conversion lens 158 are aligned. The conversion lens 158 can align a focal point of the camera 154 with the side portion of the small size sheet SP (see FIG. 4) in the width direction (the arrow Z direction) by changing a focal distance.

On the other hand, when the small size guide 152 is removed from the state in which the camera 154 is at the movement position P4 (see FIG. 17), the plate-shaped piece 180 is disengaged from the protruding piece 176 of the holding portion 172. Accordingly, due to the urging force of the coil spring 174, the holding portion 172 moves upward in the vertical direction, and the support body 168 moves in a direction away from the conversion lens 158 while the first inclined surface 169 of the support body 168 slides on the second inclined surface 173 of the holding portion 172 (see FIGS. 14 and 15). As described above, since the spring force of the coil spring 174 is stronger than the spring force of the coil spring 170, the support body 168 easily moves in the direction away from the conversion lens 158 by being pressed by the holding portion 172. Accordingly, the camera 154 supported by the support body 168 moves to the original normal position P3 before the small size guide 152 is attached. That is, the holding portion 172 can hold the camera 154 at the normal position P3, at which the sheet P of the normal size can be photographed, against the urging force of the coil spring 170.

The medium accommodating device 150 of the third exemplary embodiment has the following actions and effects in addition to the actions and effects of the same configuration as the medium accommodating device 10 of the first exemplary embodiment.

In the medium accommodating device 150, the conversion lens 158 is attached to the small size guide 152. The medium accommodating device 150 is provided with the moving device 156 that moves the camera 154 to the movement position P4 facing the conversion lens 158 in conjunction with the attachment of the small size guide 152 when the small size guide 152 is attached to the loading unit 12 via the side guide 20. Therefore, in the medium accommodating device 150, compared to a case where the camera is moved to the movement position P4 facing the conversion lens by an operation different from the attachment of the small size guide, time and effort required for the user to adjust the positions of the camera 154 and the conversion lens 158 may be reduced.

In addition, in the medium accommodating device 150, the moving device 156 moves the camera 154 to the original normal position P3 before the small size guide 152 is attached when the small size guide 152 is removed. Therefore, in the medium accommodating device 150, compared to a case where the camera is moved to the original normal position P3 by an operation of the user when the small size guide is removed, time and effort for the user to move the camera 154 may be reduced.

In addition, in the medium accommodating device 150, the moving device 156 includes the coil spring 170 that urges the support body 168 of the camera 154 to the movement position P4 side facing the conversion lens 158. Furthermore, the moving device 156 includes the holding portion 172 that holds the camera 154 at the normal position P3, at which the sheet P of the normal size can be photographed, against the urging force of the coil spring 170. Then, the plate-shaped piece 180 provided in the small size guide 152 hits the protruding piece 176 of the holding portion 172, and the holding portion 172 releases the holding of the support body 168 of the camera 154. Therefore, in the medium accommodating device 150, compared to a case where a power unit that electrically moves the camera is provided, a cost of operating the moving device 156 may be reduced.

In addition, in the medium accommodating device 150, the moving device 156 includes the coil spring 174 that presses the holding portion 172 in the direction toward the camera 154. In addition, the support body 168 of the camera 154 is provided with the first inclined surface 169 arranged in the direction intersecting the direction in which the camera 154 moves toward the movement position P4 facing the conversion lens 158. Furthermore, the holding portion 172 is provided with the second inclined surface 173 that comes into contact with the first inclined surface 169 and moves the camera 154 to the normal position P3, at which the sheet P of the normal size can be photographed, against the urging force of the coil spring 170. Accordingly, when the small size guide 152 is removed, the holding portion 172 is pushed out by the urging force of the coil spring 170, and the first inclined surface 169 of the support body 168 slides on the second inclined surface 173 of the holding portion 172, whereby the support body 168 moves in the direction away from the conversion lens 158. Accordingly, the camera 154 supported by the support body 168 moves to the original normal position P3 before the small size guide 152 is attached.

Therefore, in the medium accommodating device 150, compared to a case where the camera is moved to the original normal position P3 by using a member different from the member that moves the camera to the conversion lens side when the small size guide is removed, a low cost may be achieved.

### Supplementary Description

In the medium accommodating devices of the first to third exemplary embodiments, the small size guides 24 and 152 are detachably provided in the side guides 20, but the present disclosure is not limited to this configuration. For example, the small size guide may be configured to be detachably provided in another member such as a bottom plate of the loading unit 12.

In addition, in the medium accommodating devices of the first to third exemplary embodiments, the cameras 18 and 154 are provided on each of both sides of the small size sheets SP in the width direction, but the present disclosure is not limited to this configuration. For example, the cameras 18 and 154 may be configured to be provided on either one side of the small size sheets SP in the width direction.

In the medium accommodating device of the first exemplary embodiment, the conversion lens 50 is configured not to come into contact with the small size guide 24, but the present disclosure is not limited to this configuration. For example, the conversion lens 50 may be configured to be movably supported by the small size guide 24.

In the medium accommodating device of the third exemplary embodiment, the coil spring 170 is provided as a member for moving the camera 154 to the movement position P4 on the conversion lens 158 side, but the present disclosure is not limited to this configuration. For example, as an example of the power unit, a solenoid or a motor may be used to move the camera 154 to the movement position P4 on the conversion lens 158 side. In this case, for example, when the small size guide is attached to the side guide or the like, the solenoid or the motor may be operated to move the camera to the movement position P4 on the conversion lens 158 side.

It should be noted that, although the present invention has been described in detail with respect to specific exemplary embodiments, the present invention is not limited to such exemplary embodiments, and it will be apparent to a person skilled in the art that various other exemplary embodiments are possible within the scope of the present invention.

### ASPECTS OF PRESENT DISCLOSURE

Hereinafter, aspects of the present disclosure will be additionally described.

(((1)))

A medium accommodating device comprising:
a loading unit on which media are loadable in an up-down direction;
a first restricting unit that is provided in the loading unit and restricts a position of a side portion of a medium in a width direction intersecting a transport direction of the medium according to a dimension of the medium in the width direction;
an air supply unit that supplies air to a plurality of the media loaded on the loading unit to float and separate the plurality of media;
a transporting unit that sequentially sends the media that are floated and separated by the air supply unit;
a photographing unit that photographs a state in which the media are floated and separated by the air supply unit from an outside of the medium in the width direction;
a second restricting unit that is attached to the loading unit when a narrow medium having dimensions in the width direction smaller than dimensions of the medium is loaded on the loading unit, and restricts a position of a side portion of the narrow medium in the width direction; and
a focal distance changing unit that is installed at a position facing the photographing unit in a state in which the second restricting unit is attached, and aligns a focal point of the photographing unit with the side portion of the narrow medium in the width direction by changing a focal distance.
   (((2)))

The medium accommodating device according to (((1))),
wherein the photographing unit is provided in the first restricting unit, and
the second restricting unit is detachably attached to the first restricting unit.
   (((3)))

The medium accommodating device according to (((1))) or (((2))),
wherein the focal distance changing unit is attached to the second restricting unit so that a position of the focal distance changing unit with respect to the photographing unit is adjustable.
   (((4)))

The medium accommodating device according to (((3))),
wherein the focal distance changing unit is provided with a male thread portion that meshes with a female thread portion of the second restricting unit and allows the focal distance changing unit to move in an axial direction.
   (((5)))

The medium accommodating device according to (((1))) or (((2))),
wherein the focal distance changing unit is attached to the second restricting unit, and
a moving unit that moves the photographing unit to a position facing the focal distance changing unit in conjunction with attachment of the second restricting unit when the second restricting unit is attached to an upper side of the loading unit is provided.
   (((6)))

The medium accommodating device according to (((5))),
wherein the moving unit moves the photographing unit to an original position before the second restricting unit is attached when the second restricting unit is removed.
   (((7)))

The medium accommodating device according to (((5))) or (((6))),
wherein the moving unit includes:
   an urging member that urges the photographing unit to a side of a position facing the focal distance changing unit; and
   a holding portion that holds the photographing unit at a position, at which the medium is photographable, against an urging force of the urging member, and
a contact portion provided in the second restricting unit hits the holding portion to release the holding of the photographing unit by the holding portion.
   (((8)))

The medium accommodating device according to (((7))),
wherein the moving unit includes:
   another urging member pressing the holding portion in a direction toward the photographing unit;
   a first inclined surface provided in the photographing unit and arranged in a direction intersecting a direction in which the photographing unit moves toward the side of the position facing the focal distance changing unit; and
   a second inclined surface that is provided in the holding portion and moves the photographing unit to the position at which the medium is photographable, against the urging force of the urging member by coming into contact with the first inclined surface.
      (((9)))

The medium accommodating device according to any one of (((1))) to (((8))),
wherein the second restricting units are attached to both sides of the narrow medium in the width direction, and
the photographing units are respectively provided on both sides of the narrow medium in the width direction.
   (((10)))

The medium accommodating device according to any one of (((1))) to (((9))), further comprising:
at least one processor,
wherein the processor is configured to:
   change an amount of air supplied by the air supply unit based on an image photographed by the photographing unit.
      (((11)))

An image forming system comprising:
the medium accommodating device according to any one of (((1))) to (((9))); and
an image forming unit that forms an image on a recording medium sent from the medium accommodating device by the transporting unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A medium accommodating device comprising:
a loading unit on which media are loadable in an up-down direction;
a first restricting unit that is provided in the loading unit and restricts a position of a side portion of a medium in a width direction intersecting a transport direction of the medium according to a dimension of the medium in the width direction;
an air supply unit that supplies air to a plurality of the media loaded on the loading unit to float and separate the plurality of media;
a transporting unit that sequentially sends the media that are floated and separated by the air supply unit;
a photographing unit that photographs a state in which the media are floated and separated by the air supply unit from an outside of the medium in the width direction;
a second restricting unit that is attached to the loading unit when a narrow medium having dimensions in the width direction smaller than dimensions of the medium is loaded on the loading unit, and restricts a position of a side portion of the narrow medium in the width direction; and
a focal distance changing unit that is installed at a position facing the photographing unit in a state in which the second restricting unit is attached, and aligns a focal point of the photographing unit with the side portion of the narrow medium in the width direction by changing a focal distance.

2. The medium accommodating device according to claim 1,
wherein the photographing unit is provided in the first restricting unit, and
the second restricting unit is detachably attached to the first restricting unit.

3. The medium accommodating device according to claim 1,
wherein the focal distance changing unit is attached to the second restricting unit so that a position of the focal distance changing unit with respect to the photographing unit is adjustable.

4. The medium accommodating device according to claim 3,
wherein the focal distance changing unit is provided with a male thread portion that meshes with a female thread portion of the second restricting unit and allows the focal distance changing unit to move in an axial direction.

5. The medium accommodating device according to claim 1,
wherein the focal distance changing unit is attached to the second restricting unit, and
a moving unit that moves the photographing unit to a position facing the focal distance changing unit in conjunction with attachment of the second restricting unit when the second restricting unit is attached to an upper side of the loading unit is provided.

6. The medium accommodating device according to claim 5,
wherein the moving unit moves the photographing unit to an original position before the second restricting unit is attached when the second restricting unit is removed.

7. The medium accommodating device according to claim 5,
wherein the moving unit includes:
an urging member that urges the photographing unit to a side of a position facing the focal distance changing unit; and
a holding portion that holds the photographing unit at a position, at which the medium is photographable, against an urging force of the urging member, and
a contact portion provided in the second restricting unit hits the holding portion to release the holding of the photographing unit by the holding portion.

8. The medium accommodating device according to claim 7,
wherein the moving unit includes:
another urging member pressing the holding portion in a direction toward the photographing unit;
a first inclined surface provided in the photographing unit and arranged in a direction intersecting a direction in which the photographing unit moves toward the side of the position facing the focal distance changing unit; and
a second inclined surface that is provided in the holding portion and moves the photographing unit to the position at which the medium is photographable, against the urging force of the urging member by coming into contact with the first inclined surface.

9. The medium accommodating device according to claim 1,
wherein the second restricting units are attached to both sides of the narrow medium in the width direction, and
the photographing units are respectively provided on both sides of the narrow medium in the width direction.

10. The medium accommodating device according to claim 1, further comprising:
at least one processor,
wherein the processor is configured to:
change an amount of air supplied by the air supply unit based on an image photographed by the photographing unit.

11. An image forming system comprising:
the medium accommodating device according to claim 1; and
an image forming unit that forms an image on a recording medium sent from the medium accommodating device by the transporting unit.

12. An image forming system comprising:
the medium accommodating device according to claim 2; and
an image forming unit that forms an image on a recording medium sent from the medium accommodating device by the transporting unit.

13. An image forming system comprising:
the medium accommodating device according to claim 3; and
an image forming unit that forms an image on a recording medium sent from the medium accommodating device by the transporting unit.

14. An image forming system comprising:
the medium accommodating device according to claim 4; and
an image forming unit that forms an image on a recording medium sent from the medium accommodating device by the transporting unit.

15. An image forming system comprising:
the medium accommodating device according to claim 5; and
an image forming unit that forms an image on a recording medium sent from the medium accommodating device by the transporting unit.

16. An image forming system comprising:
the medium accommodating device according to claim 6; and
an image forming unit that forms an image on a recording medium sent from the medium accommodating device by the transporting unit.

17. An image forming system comprising:
the medium accommodating device according to claim 7; and
an image forming unit that forms an image on a recording medium sent from the medium accommodating device by the transporting unit.

18. An image forming system comprising:
the medium accommodating device according to claim 8; and
an image forming unit that forms an image on a recording medium sent from the medium accommodating device by the transporting unit.

19. An image forming system comprising:
the medium accommodating device according to claim 9; and
an image forming unit that forms an image on a recording medium sent from the medium accommodating device by the transporting unit.

20. An image forming system comprising:
the medium accommodating device according to claim 10; and
an image forming unit that forms an image on a recording medium sent from the medium accommodating device by the transporting unit.
